(19) United States
(12) Patent Application Publication
(10) Pub. No.: US 2008/0298960 A1
(43) Pub. Date: Dec. 4, 2008

(54) Micro-Air Motor

(75) Inventors: Thomas Mueller, Langendorf (CH); Daniel Mueller, Langendorf (CH); Kurt Mueller, Langendorf (CH)

Correspondence Address: KAPLAN GILMAN GIBSON & DERNIER L.L.P., 900 ROUTE 9 NORTH, WOODBRIDGE, NJ, 07095, US

(73) Assignee: ROTOMED AG, Bellach (CH)

(21) Appl. No.: 11/995,998

(22) PCT Filed: Jul. 21, 2006
(86) PCT No.: PCT/IB2006/002000

§ 371 Date: Jun. 16, 2008

(30) Foreign Application Priority Data
Jul. 22, 2005 (CH) 01225/05

(51) Int. Cl. F03B 3/18

(52) U.S. Cl. 415/208.1

(57) ABSTRACT

A micro-air motor comprises a collector rotatably mounted in a casing for the compressed air supply and discharge to or from the rotor. By twisting the collector as far the end positions a direction of rotation reversal as well as continuous speed regulation is possible. In a neutral position of the collector the rotor can be additionally stopped and locked.

### BACKGROUND

The invention relates to a micro-air motor with a casing comprising a guide bore and a rotor rotatably mounted therein, wherein the rotor is provided with slots substantially oriented radially outwards, in which plate-shaped vanes are mounted radially displaceable outwards through the centrifugal force and a collector axially following the rotor with inlet and outlet apertures and with channels connected to external connections for the compressed air, wherein the collector (6) is rotatably arranged about the axis of rotation of the rotor (2) or about an axis parallel to said rotor or about the longitudinal axis of the casing (1) by means of an actuation sleeve (4).

Air motors with radially displaceable vanes are built and used in different sizes and for quite different applications. The devices designated “micro-air motors” as a rule have a casing diameter of less than two centimetres and are predominantly used in medical equipment, more preferably surgery and neurosurgery. The plurality of the devices known and employed to date can only be operated in one direction of rotation. This is due to the cross sections of the inlet and outlet apertures usually differing in size in order to achieve optimum speed and performance characteristics. If the inlet and outlet apertures are identically dimensioned direction of rotation reversal is possible but the device does not generate the optimum but only a limited output in both directions of rotation.

From WO 81/03520 a vacuum motor is known that can be operated in both directions of rotation. Here, the handle connected to a vacuum line can be twisted about the casing towards both sides into fixed end positions. Thus the handle additionally has the function of a rotary valve. Thus, the one or the other aperture of the casing can be connected to the vacuum line or the ambient air.

However the inlet and outlet apertures are thus always identical in size. Optimum operation of the motor is thus not possible in both directions of rotation.

A vane motor known from GB 1 578 364, which likewise is used in medical equipment, comprises a total of three connection apertures, wherein the one aperture always serves as outlet and the other two apertures, depending on the direction of rotation, optionally serve as inlet or outlet. This device thus has improved performance characteristics in both directions of rotation compared with a device having only two apertures. However, a special external valve is necessary for the control which is not disclosed in this publication.

From U.S. Pat. No. 4,708,210 a pneumatically operable hand tool is known which comprises a collector that can be twisted by means of an actuation ring. In both its end positions the collector serves for the reversal of the direction of rotation of the motor. The speed is controlled via a separate throttle valve. This design is involved and not very user-friendly.

### SUMMARY OF THE INVENTION

The invention is based on the object of creating a micro-air motor which is reversible and has optimum speed and performance characteristics in both directions of rotation.

According to the invention this is achieved in that the collector (6) can be brought from a central neutral position stopping the rotor (2) towards both sides as far as an end position limited through stops, so that the rotor (2)—under compressed air—rotates anti-clockwise or clockwise.

The collector is a device-internal component which is practically present in different form in any air or micro-air motor. The rotatability of the collector can for example be achieved in a simple manner in that the collector on its outside is substantially designed cylindrically and is rotatably mounted in a corresponding bore of the casing.

A practical embodiment consists in that the collector can be brought from a central neutral position rotationally locking the rotor—under compressed air—to both sides into an end position limited through stops, in which the rotor—under compressed air—rotates anti-clockwise or clockwise. Thus the rotor is fixed in the neutral position of the collector and thus not freely rotatable. This produces substantial advantages for example during the tool change in that an additional locking device for the rotor is not required. A separate shut-off organ for stopping the air motor is not per se necessary either.

For controlling or regulating the air motor it is advantageous that the collector is continuously rotatable as far as the end positions. The speed of the air motor can thus be controlled practically continuously from zero to the maximum speed by enlarging the flow cross section.

For actuating the collector it is practically coupled with an actuation sleeve. Coupling can be effected for example by means of key, pin or screw-type fasteners. These fasteners can simultaneously interact also with corresponding guides or cranks and control or limit the twisting path of the collector.

The inlet and outlet apertures advantageously have different cross sections. As a result, these can be optimally adapted to the requirements, i.e. the outlet apertures in the region of the outflowing exhaust air can be dimensioned substantially larger than the inlet apertures in the region of the supply air inflowing with high pressure. Thus the air resistance can be optimally maintained over the entire flow path.

Practically the inlet and/or outlet apertures are designed kidney-shaped. In interaction with the working chamber of the air motor which is usually ring or wedge-shaped this produces favourable flow conditions at the transition points of the collector to the rotor in all positions of twist of the collector.

Since the compressed air to the rotor is supplied and discharged usually axially, it is advantageous that at least one channel is oriented coaxially or parallel to the axis of the rotor. Such an arrangement also makes possible a compact and slim design of the compressed air motor or the entire device. This is more preferably highly desirable and of great advantage with devices employed in medical equipment.

A further advantageous embodiment consists in that in the region of the vanes between the outside of the rotor and the guide bore of the casing a freely rotatable floating sleeve enveloping the outside of the vanes is arranged, which, on its shell, comprises at least one passage bore arranged on the circumference and/or irregularly distributed over the length of the floating sleeve substantially oriented radially or designed as slots substantially oriented in longitudinal direction of the floating sleeve or helically. Through the floating sleeve, contact of the vanes with the guide bore or the casing and thus wear of the vanes on their outside is avoided.

The floating sleeve and/or the vanes practically consist of plastic, preferentially of phenolic resin fabric. Such materials have a relatively low specific weight, good temperature resistance and favourable friction conditions.

The longitudinal slots for the vanes are advantageously arranged in the radial planes through the rotor. Thus the rotor has the same running characteristics in both directions of rotations.

Practically at least two to six, preferentially four vanes are provided. The higher the number of vanes the more even are the running characteristics and the torque curve of an air motor over one rotation.

### DESCRIPTION OF THE FIGURES

The invention is explained in more detail in the following by means of the drawings exemplarily representing the invention. It shows:

FIG. 1 a micro-air motor according to the invention in longitudinal section,

FIG. 2 a cross section through the micro-air motor shown in FIG. 1 along the line A-A,

FIG. 3 a cross section through the micro-air motor shown in FIG. 1, along the line B-B, with the micro-air motor stationary,

FIG. 4 a cross section through the micro-air motor shown in FIG. 1 along the line B-B, with the micro-air motor rotating clockwise, and

FIG. 5 a cross section through the micro-air motor shown in FIG. 1 along the line B-B, with the micro-air motor rotating anti-clockwise.

### DETAILED DESCRIPTION OF THE INVENTION

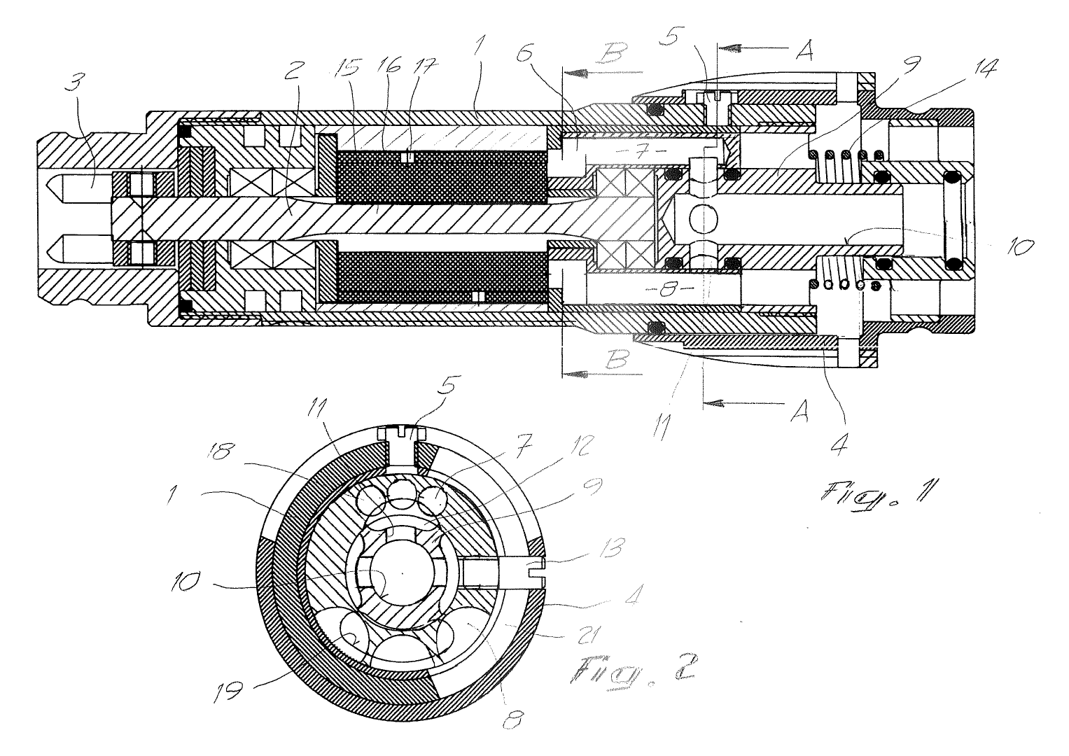

The micro-air motor shown in FIG. 1 to FIG. 5 comprises a casing 1 with a rotor 2 rotatably mounted in said casing. The free end of the rotor 2 is connected with a tool holder 3 for accommodating exchangeable tools. At its rearward end the casing 1 is surrounded by an actuation sleeve 4. The actuation sleeve 4 is axially displaceable to a limited extent against the force of a spring 14 and in the process also controls the compressed air supply. A stop 5 limits the axial displacement path of the actuation sleeve 4. In the casing 1 a collector 6 is mounted capable of being twisted to a limited extent.

The collector 6 comprises longitudinal bores 7 and channels 8 oriented in axial direction which are open towards the outside for the compressed air supply and discharge. An adapter 9 is securely connected with the housing 1. The adapter 9 is provided with a central bore 10 as well as with transverse bores 11 terminating in the central bore 10. Through milled portions 12 the connection between the transverse bores 11 and the longitudinal bores 7 of the collector 6 is established.

As is evident from FIG. 2, the actuation sleeve 4 is connected with the collector 6 in a rotationally fixed manner via a grub screw 13. The grub screw 13 engages through a slot 21 of the casing 1 which runs over a part of the circumference. Thus through twisting of the actuation sleeve 4 the collector 6 coupled with said actuation sleeve can likewise be twisted. The end positions on the one hand are limited through the slot 21 in the casing 1 and on the other hand also through the stop 5.

In longitudinal slots 20 of the rotor 2 vanes 15 mounted radially displaceably are arranged. The vanes 15 on their outer side are surrounded by a floating sleeve 16. The floating sleeve 16 is provided with passage apertures 17 for the compressed air. Thus the same pressure exists on both sides of the floating sleeve 16 and the floating sleeve 16 is thus mounted in a floating manner and practically free of friction. The longitudinal bores 7 terminate in an inlet aperture 18 and the channels 8 in an outlet aperture 19.

FIG. 3 shows the collector 6 in the neutral position corresponding to FIG. 2. Here, the vane 15 in the region of the inlet aperture 18 is subjected to the same pressure from both sides. The outlet aperture 19 on the side opposite to that of the inlet aperture 18 is connected with the spaces on both sides of the vane 15. The rotor 2 is stopped in the angle of rotation position of the collector 6.

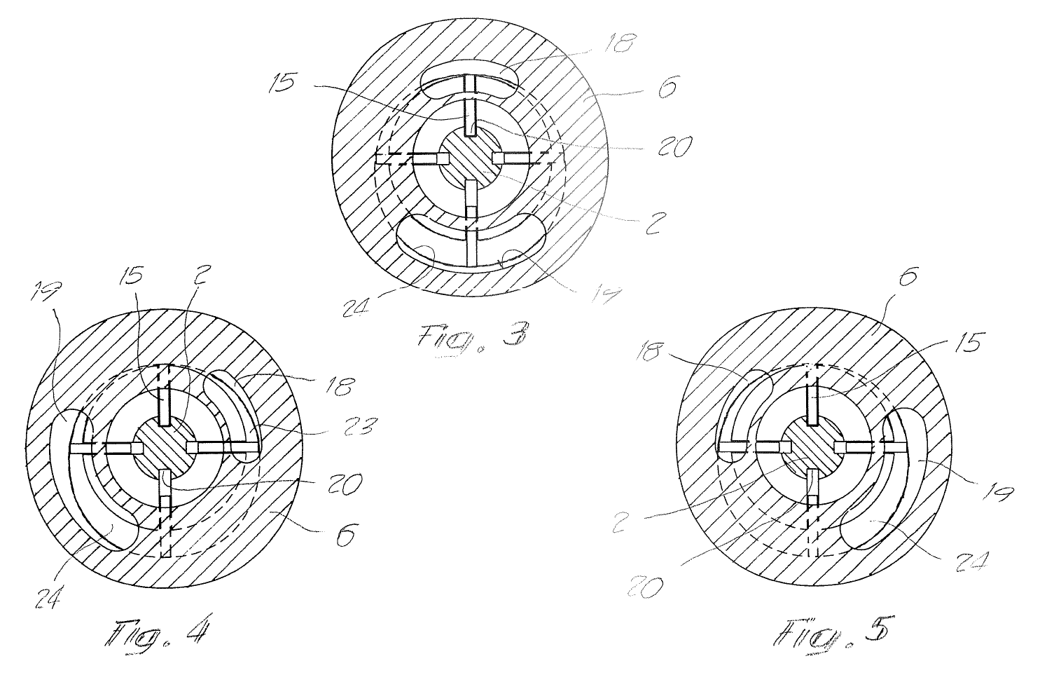

In the position shown in FIG. 4 the collector 6 is twisted by an angle of approximately 60° in clockwise direction relative to the position shown in FIG. 3. The inlet aperture 18 is now connected with the working chamber 23, so that through the air pressure the rotor 2 rotates in clockwise direction. On the opposite side the working chamber 24 terminates in the outlet aperture 19. If the collector 6 is twisted back into the starting position shown in FIG. 3 the rotor 2 is again stopped.

If the collector 6 is twisted in anti-clockwise direction as far as the other end position shown in FIG. 5 the rotor 2 rotates in anti-clockwise direction because of the reversed conditions. Through any intermediate positions between the extreme positions shown in FIGS. 4 and 5 and the neutral position shown in FIG. 3 the speed of the rotor 2 can be continuously regulated.

As is evident from FIG. 3 to 5 the inlet apertures 18 and outlet apertures 19 are substantially designed kidney-shaped in cross section. As a result, optimum adjustment of the flow in the transition region from the inlet aperture 18 and the outlet aperture 19 to the working chamber 23 and 24 is possible.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### LIST OF REFERENCE NUMBERS

1 Casing
2 Rotor
3 Tool holder
4 Actuation sleeve
5 Stop
6 Collector
7 Longitudinal bore
8 Channel
9 Adapter
10 Central bore
11 Transverse bore
12 Milled portion
13 Grub screw
14 Spring
15 Vane
16 Floating sleeve
17 Passage aperture
18 Inlet aperture
19 Outlet aperture
20 Longitudinal slot
21 Slot
23 Working chamber
24 Working chamber

1-11. (canceled)

12. A micro-air motor, comprising:
a casing;
a guide bore and a rotor rotatably mounted in said casing, wherein the rotor is provided with slots substantially oriented radially outwards;
plate-shaped vanes operatively mounted to the rotor such that they are radially displaceable outwards through centrifugal force;
a collector axially adjoining the rotor with inlet and outlet apertures and with outer connections for compressed air connected channels, the collector being arranged rotatable about an axis of rotation of the rotor, about an axis parallel to said rotor, or about a longitudinal axis of the casing (1) by means of an actuation sleeve, and the collector being operable to twist from a central neutral position stopping the rotor to both sides as far as an end position, so that the rotor—under compressed air—rotates anti-clockwise or clockwise; and
a freely rotatable floating sleeve enveloping an outer side of the vanes arranged in a region of the vanes between an outer side of the rotor and the guide bore of the casing, and including at least one passage aperture arranged on a circumference of, and/or irregularly distributed over a length of, the floating sleeve, the at least one passage aperture being designed as radially oriented bores or as slots substantially oriented in a longitudinal direction of the floating sleeve or helically.

13. The micro-air motor according to claim 12, wherein the collector is operable to twist continuously as far as the end positions.

14. The micro-air motor according to claim 12, wherein the collector is coupled to the actuation sleeve.

15. The micro-air motor according to claim 12, wherein the inlet and outlet apertures have different cross sections.

16. The micro-air motor according to claim 15, wherein the inlet and/or outlet apertures are designed kidney-shaped in cross section.

17. The micro-air motor according to claim 12, wherein at least one channel is oriented coaxially or parallel to the axis of the rotor.

18. The micro-air motor according to claim 1, wherein the floating sleeve and/or the vanes include at least one of plastic, and phenolic resin fabric.

19. The micro-air motor according to claim 12, wherein the longitudinal slots for the vanes are arranged in radial planes through the rotor.

20. The micro-air motor according to claim 12, wherein at about two to six, vanes are provided.

21. The micro-air motor according to claim 20, wherein four vanes are provided.
